(19) United States
(12) Patent Application Publication
(10) Pub. No.: US 2014/0241484 A1
(43) Pub. Date: Aug. 28, 2014

(54) PRESSURIZED WATER REACTOR DEPRESSURIZATION SYSTEM

(71) Applicant: WESTINGHOUSE ELECTRIC COMPANY LLC, Cranberry Township, PA (US)

(72) Inventors: Jun Liao, Export, PA (US); Vefa N. Kucukboyaci, Pittsburgh, PA (US)

(73) Assignee: Westinghouse Electric Company LLC, Cranberry Township, PA (US)

(21) Appl. No.: 13/778,565

(22) Filed: Feb. 27, 2013

(51) Int. Cl. G21C 9/004

(52) U.S. Cl. CPC G21C 9/004
USPC 376/283

(57) ABSTRACT

A passive cooling system of a pressurized water reactor that relies on a depressurization system to reduce the pressure in the reactor vessel in the event of a loss of coolant accident and vent the steam generated by the decay heat of the reactor core in a post loss of coolant accident stage. The depressurization results in a low pressure difference between the reactor vessel and the containment and enables gravity driven cooling system injection into the reactor vessel. The depressurization system includes a flow restrictor within an orifice in the reactor vessel wall that connects to a vent pipe which forms a flow path between the interior of the reactor vessel and the containment atmosphere when a valve within the vent pipe is in an open position. Preferably, the flow restrictor is a venturi that has a gradual contraction and a gradual expansion in the flow path area.

### BACKGROUND

1. Field

This invention relates generally to nuclear reactors and in particular to pressurized water nuclear reactor systems having passive safety features with automatic depressurization of the reactor coolant circuit to facilitate the injection of additional cooling water into the cooling circuit.

2. Related Art

In a nuclear reactor for power generation, such as a pressurized water reactor, heat is generated by fission of a nuclear fuel such as enriched uranium, and transferred to a coolant flowing through a reactor core. The core contains elongated nuclear fuel rods mounted in proximity with one another in a fuel assembly structure, through and over which the coolant flows. The fuel rods are spaced from one another in co-extensive parallel arrays. Some of the neutrons and gamma rays released during nuclear fission in a given fuel rod pass through the water moderator in between fuel rods and impinge on fissile material in adjacent fuel rods, contributing to the nuclear reaction and to the heat generated within the core.

Moveable control rods are dispersed throughout the nuclear core to enable control of the overall rate of the fission reaction, by absorbing a portion of the neutrons, which otherwise would contribute to the fission reaction. The control rods generally comprise elongated rods of neutron absorbing material and fit into longitudinal openings or guide thimbles in the fuel assemblies running parallel to and between the fuel rods. Inserting a control rod further into the core causes more neutrons to be absorbed without contributing to the fission reaction in an adjacent fuel rod; and retracting the control rods reduces the extent of neutron absorption and increases the rate of the nuclear reaction and the power output of the core.

FIG. 1 shows a simplified conventional nuclear reactor primary system, including a generally cylindrical pressure vessel 10 having a closure head 12 enclosing a nuclear core 14 that supports the fuel rods containing the fissile material. A liquid coolant, such as water or borated water, is pumped into the vessel 10 by pumps 16 through the core 14 where heat energy is absorbed and is discharged to a heat exchanger 18 typically referred to as a steam generator, in which heat is transferred to a utilization circuit (not shown) such as a steam driven turbine generator. The reactor coolant is then returned to the pump 16 completing the primary loop. Typically, a plurality of the above-described loops are connected to a single reactor vessel 10 by reactor coolant piping 20.

Commercial power plants employing this design typically generate between 300 MW to 1700 MW of electric power. More recently, Westinghouse Electric Company LLC has proposed a small modular reactor in the 200 megawatt electric class. The small modular reactor is an integral pressurized water reactor with all primary loop components located inside the reactor vessel. The reactor vessel is surrounded by a compact, high pressure containment. Due to both the limited space within the containment and the low cost requirement for integral pressurized light water reactors, the overall number of auxiliary systems needs to be minimized without compromising safety or functionality. For that reason, it is desirable to maintain most of the components in fluid communication with the primary loop of the reactor system within the compact, high pressure containment.

Typical conventional pressurized water reactor designs make use of active safety systems that rely on emergency AC power after an accident to power the pumps required to cool down the reactor and the spent fuel pool. Advanced designs, like the AP1000®, offered by Westinghouse Electric Company LLC make use of passive safety systems that only rely on natural circulation, boiling and condensation to remove the decay heat from the core and the spent fuel pool. It is desirable to apply these passive safety system principles to a small modular reactor design and preferably simplify the design while still maintaining the safety margins. One such safety system addresses a loss of coolant accident from the primary coolant circuit. A loss of coolant accident may involve only a small quantity, whereby additional coolant can be injected from a relatively small high pressure make-up water supply, without depressurizing the reactor coolant circuit. If a major loss of coolant accident occurs, it is necessary to add coolant from a lower pressure supply containing a large quantity of water. To overcome the substantial pressure of the reactor coolant circuit, e.g., 2250 psi or 15 MPa, the reactor coolant circuit is depressurized so that coolant water can be added from a low pressure water supply tank within the containment. Inasmuch as the low pressure water supply tank drains by gravity, no pumps are required. Draining the water into the bottom of the containment vessel where the reactor vessel is located, develops a fluid pressure head of water in the containment sufficient to force water into the depressurized cooling circuit without relying on active components such as pumps. Once the cooling circuit is substantially at the ambient pressure within the containment and the containment is flooded, water continues to be forced into the reactor vessel, where the water cools the nuclear fuel. Liquid water together with steam generated in the core escape from the reactor coolant circuit. Steam is condensed on the inside walls of the containment and other metal surfaces inside the containment and drained back to be injected again into the reactor coolant circuit.

The foregoing arrangement is effective in the scenario of a loss of coolant accident. However, there is a potential that if the automatic depressurization system is activated in less dire circumstances, the containment may be flooded needlessly. Depressurization followed by flooding of the reactor containment requires shutdown of the reactor and a significant cleanup effort. This concern has been partially addressed in U.S. Pat. No. 5,268,943 and U.S. Patent Application Publication No. 2012/0155597, assigned to the assignee of this invention.

It has been postulated that a spurious actuation of the automatic depressurization system under normal conditions could lead to an accident that is more severe than has been analyzed. Accordingly, a further improvement in the automatic depressurization system is desired to minimize the adverse impact of such an occurrence. Thus, it is an object of this invention to add flow resistance to the discharging of reactor coolant to the containment.

It is a further object of this invention to add such resistance without adversely impacting the operation of the depressurization system to enable water to be added to the coolant circuit by gravity flow from the low pressure water supply tank at a rate sufficient to keep the reactor core covered with water.

### SUMMARY

These and other objects are achieved by a nuclear power generation system having a reactor enclosed within a pressure vessel housed within a containment with the reactor operating at a higher pressure than the area surrounding the reactor within the containment. The reactor includes a depressurization system for reducing the pressure within the reactor by venting the coolant within the reactor into the containment. The depressurization system basically comprises an orifice within the pressure vessel for venting the coolant within the pressure vessel into the containment and a flow restrictor in flow communication with the orifice for restricting the critical flow rate of a fluid within the pressure vessel out of the orifice while enabling sufficient flow of a fluid to substantially equalize the pressure within the pressure vessel with the pressure outside the pressure vessel. Desirably, the flow restrictor has a reduced opening as compared to other conduits in the depressurization system, that is gauged to provide the minimum critical flow required by the depressurization system to maintain the reactor core covered with coolant. Preferably, the flow restrictor is a venturi having a gradual transition between a maximum diameter and a minimum diameter of an opening through the venturi within which the depressurization is communicated.

In one embodiment, the orifice extends through a wall of the pressure vessel and includes a conduit that extends from the pressure vessel to a valve for isolating the orifice until the depressurization system is actuated. Preferably, the flow restrictor is positioned through the orifice in a wall of the pressure vessel and desirably the flow restrictor is positioned within the pressure vessel wall. Effectively, the flow area of the flow restrictor is less than the flow area of the conduit or the valve.

In one embodiment, the nuclear power generator system is a conventional, commercial, pressurized water reactor. In another embodiment, the nuclear power generation system is a small modular pressurized water reactor as compared to conventional nuclear reactors typically between approximately 300 and 1700 megawatts electric.

### BRIEF DESCRIPTION OF THE DRAWINGS

A further understanding of the invention can be gained from the following description of the preferred embodiments when read in conjunction with the accompanying drawings in which:

FIG. 1 is a simplified schematic of a conventional nuclear reactor system;

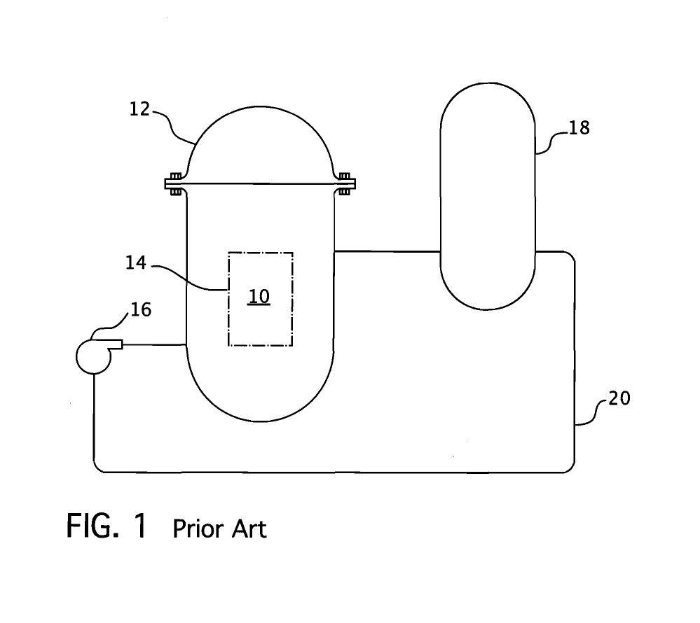

FIG. 2 is a perspective view, partially cut away, showing a small modular integral reactor system incorporating one embodiment of this invention;

FIG. 3 is an enlarged view of the reactor shown in FIG. 2;

FIG. 4 is a schematic view of the reactor containment shown in FIG. 2, and some of the auxiliary systems which support an understanding of the operation of the core make-up tanks, the depressurization system, the in-containment pool, including the operation of the outside reactor containment components of the combined passive residual heat removal system and outside-containment pool system of one embodiment of the passive safety systems of a small modular reactor;

FIG. 5 is a schematic view of a reactor vessel within a containment showing the reactor vessel wall in which an embodiment of this invention is incorporated;

FIG. 6 is a cross sectional view of the reactor wall identified in FIG. 5 in which an embodiment of this invention is incorporated; and

FIGS. 7, 8 and 9 are graphic plots for cases with and without a flow restrictor that show a reduction with the flow restrictor in the total mass released into the containment, total energy released into the containment, and containment pressure, respectively, during an inadvertent valve actuation.

### DESCRIPTION OF THE PREFERRED EMBODIMENT

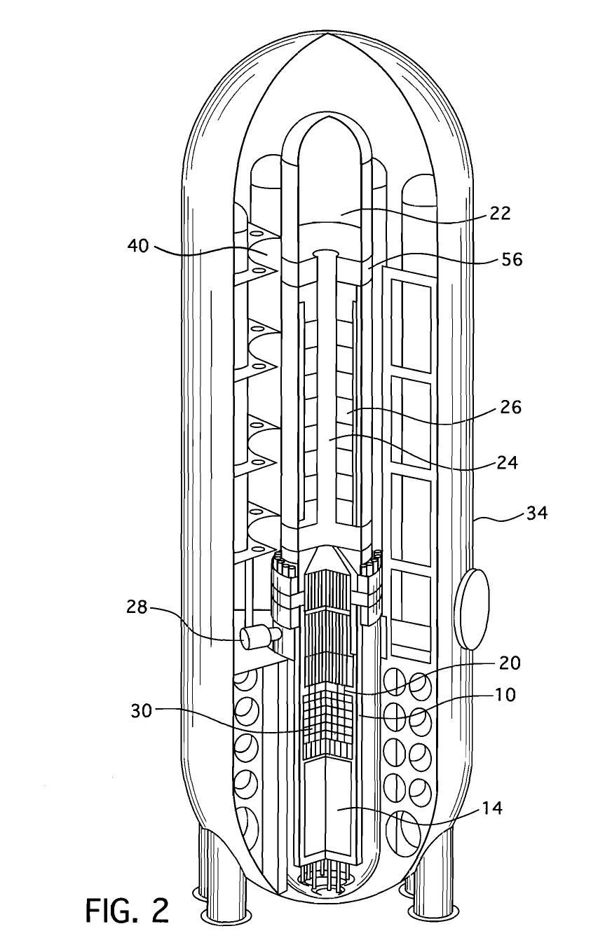

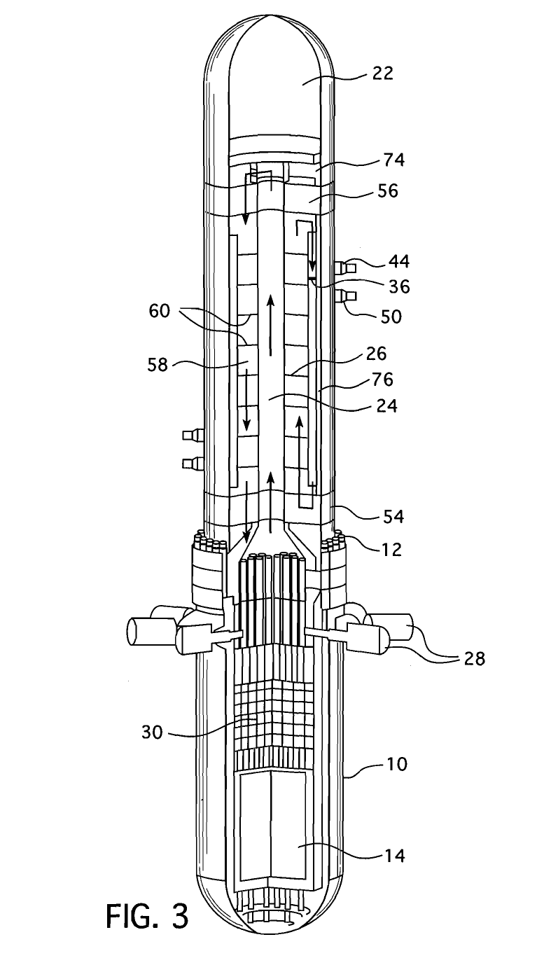

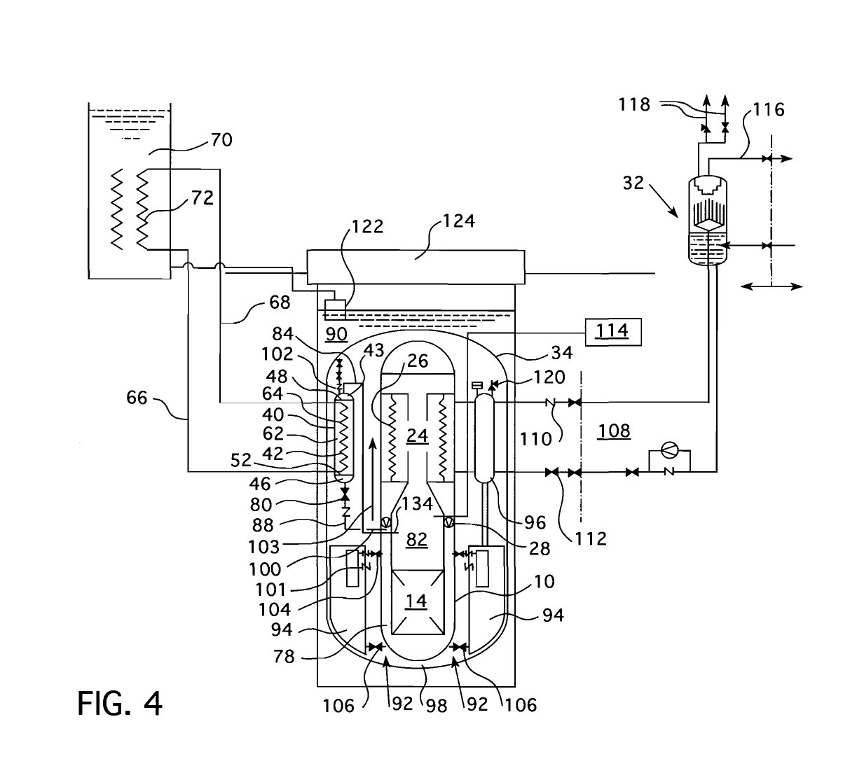

FIGS. 2, 3 and 4 illustrate a small modular reactor design having a passive heat removal system, high pressure water injection system, low pressure water injection system and recirculation system which benefits from this invention. FIG. 2 shows a perspective view of the containment of a modular reactor design to which this invention can be applied. The reactor containment illustrated in FIG. 2 is partially cut away, to show the reactor pressure vessel and its integral, internal components. FIG. 3 is an enlarged view of the reactor pressure vessel shown in FIG. 2. FIG. 4 is a detailed schematic view of one embodiment of the reactor which includes the major components of an extended passive core cooling and coolant recirculation system as well as some of the reactor auxiliary systems, including an ultimate heat sink and secondary heat exchange loop of the combined passive heat removal system and high head water injection system of one embodiment of the small modular reactor. Like reference characters are used among the several figures to identify corresponding components.

In an integral pressurized water reactor such as illustrated in FIGS. 2, 3, and 4, substantially all of the components typically associated with the primary side of a nuclear steam supply system are contained in a single reactor pressure vessel 10 that is typically housed within a high pressure containment vessel 34 capable of withstanding pressures of approximately 250 Psig (1.7 MPa), along with portions of the safety systems associated with the primary side of the nuclear steam supply system. The primary components housed within the reactor vessel 10 include the primary side of a steam generator, reactor coolant pumps 28, a pressurizer 22 and the reactor itself. The steam generator system 18 of a commercial reactor, in this integral reactor design, is separated into two components, a heat exchanger 26 which is located in the reactor vessel 10 above the reactor upper internals 30 and a steam drum 32 which is maintained external to the containment 34 as shown in FIG. 4. The steam generator heat exchanger 26 includes within the pressure vessel 10/12, which is rated for primary design pressure and is shared with the reactor core 14 and other conventional reactor internal components, two tube sheets 54 and 56, hot leg piping 24 (also referred to as the hot leg riser), heat transfer tubes 58 which extend between the lower tube sheet 54 and the upper tube sheet 56, tube supports 60, secondary flow baffles 36 for directing the flow of the secondary fluid medium among the heat transfer tubes 58 and secondary side flow nozzles 44 and 50.

The heat exchanger 26 within the pressure vessel head assembly 12 is thus sealed within the containment 34. The external to containment steam drum 32 (shown in FIGS. 4) is comprised of a pressure vessel 38, rated for secondary design pressure. The external to containment steam drum 32 includes centrifugal type and Chevron type moisture separation equipment, a feed water distribution device and flow nozzles for dry steam, feed water, recirculating liquid and wet steam, much as is found in the conventional steam generator design 18.

The flow of the primary reactor coolant through the heat exchanger 26 in the head 12 of the vessel 10 is shown by the arrows in the upper portion of FIG. 3. As shown, heated reactor coolant exiting the reactor core 14 travels up and through the hot riser leg 24 through the center of the upper tube sheet 56 where it enters a hot leg manifold 74 where the heated coolant makes a 180° turn and enters the heat transfer tubes 58 which extend through the upper tube sheet 56 and down through the lower tube sheet 54. The reactor coolant then travels down through the heat transfer tubes 58 that extend through the lower tube sheet 54 transferring its heat to a mixture of recirculated liquid and feed water that is entering the heat exchanger through the sub-cooled recirculation inlet nozzle 50 from the external steam drum 32, in a counter-flow relationship. The sub-cooled recirculating liquid and feed water that enters the heat exchanger 26 through the sub-cooled recirculation inlet nozzle 50 is directed down to the bottom of the heat exchanger by the secondary flow baffles 36 and up and around heat exchanger tubes 58 and turns just below the upper tube sheet 56 into an outlet channel 76 where the moisture-laden steam is funneled to the wet steam outlet 44. The wet saturated steam is then conveyed to the external steam drum 32 where it is transported through moisture separators which separate the steam from the moisture. The separated moisture forms the recirculated liquid which is combined with feed water and conveyed back to the sub-cooled recirculation inlet nozzle 50 to repeat the cycle.

Both conventional pressurized water reactor designs and advanced pressurized water reactor designs (such as the AP1000® offered by Westinghouse Electric Company LLC, Cranberry Township, Pa.) make use of both decay heat removal systems and high pressure injection systems to prevent core damage during accident scenarios. In the Westinghouse small modular reactor design, illustrated in FIGS. 2, 3 and 4, cost and space constraints limit the capacity of these systems as currently implemented in the larger pressurized water reactors. The larger reactor systems are more fully described in U.S. Pat. No. 5,259,008, issued Nov. 2, 1993 to the assignee of this application. The Westinghouse small modular reactor combines the passive decay heat removal, high head water injection, low head water injection, and recirculation functions into a single, simple, integrated system. This combined safety system greatly simplifies the integral reactor design as compared to the larger pressurized water reactor safety systems, and allows for comparable reactor protection capabilities during accidents at a decreased cost and with lower spatial requirements. The small modular reactor safety systems described hereafter includes a recirculation system design that can continuously cool the reactor core for approximately seven days without operator intervention or the use of external power. The initial passive cooling time may be further extended by replenishing the water in an ultimate heat sink pool outside the containment as will be described hereafter.

As can be viewed from FIGS. 2-5, the safety system of the small modular reactor includes three basic functions: a high head water injection function in which water under pressure is forced into the core in a recirculation loop through the core makeup tank; a residual heat removal system which cools the reactor coolant circulating through the core makeup tank, low head water injection system, and a core recirculation system that continually recirculates coolant through the core. The combined high head water injection function and residual passive heat removal function can be understood by referring to FIGS. 2-4, which show a combined core makeup tank/passive residual heat removal heat exchanger 40/42 located within the containment vessel 34, with the passive residual heat removal heat exchanger 42 located within the core makeup tank 40. The passive residual heat removal heat exchanger 42 includes an inlet plenum 43 at the top end of the core makeup tank and an outlet plenum 46 at the lower end of the core makeup tank. An upper tube sheet 48 separates the upper inlet plenum 43 from a secondary fluid plenum 64 and a lower tube sheet 52 separates the lower outlet plenum 46 from the secondary fluid plenum 64. A tube bundle 62 of heat exchange tubes extends between the upper tube sheet 48 and the lower tube sheet 52. Accordingly, primary fluid from the hot leg of the core 82, supplied through the inlet piping 84 enters the inlet plenum 43, is conveyed through the tube bundle 62 to the outlet plenum 46 and is returned to the downcomer 78 of the core 14 through the outlet piping 88. The coolant passing through the tube bundle 62 transfers its heat to a secondary fluid in the secondary fluid plenum 64 between the tube sheets 48 and 52. A secondary fluid enters the secondary fluid plenum 64 through the secondary fluid inlet piping 66, absorbs the transferred heat from the tube bundle 62 and exits through the secondary fluid outlet piping 68. The height of the core makeup tank 40, i.e., the elevation at which the core makeup tank is supported, is maximized in order to facilitate high natural circulation flow. During steady state operation, the core makeup tank 40 and the primary tube side of the passive residual heat removal heat exchanger 42 is filled with cold, borated water at the same pressure as the reactor coolant during reactor operation. This water is prevented from flowing into the reactor pressure vessel 40 by a valve 80 on the exit piping 88 on the bottom of the core makeup tank 40.

During accident conditions, the reactor protection system and safety monitoring system signal the opening of the valve 80, allowing the cold borated water in the core makeup tank to flow through the exit piping 88 and into the downcomer 78 of the reactor pressure vessel 10. Concurrently, hot reactor coolant flows from the core exit region 82 into the core makeup tank 40 through the inlet piping 84, and then into the core makeup tank inlet plenum 43. The hot reactor water then flows down through the tubes within the tube bundle 64 of the passive residual heat removal heat exchanger 42, and is cooled by cold secondary water flowing through the shell side of the passive residual heat removal heat exchanger in the secondary fluid plenum 64.

The secondary water, which is pressurized to prevent boiling, then flows upward through piping 68 to a second heat exchanger 72 in the ultimate heat sink tank 70, where it transfers heat to the cold water in the ultimate heat sink tank 70. The now cooled secondary water flows down through the return piping 66, and into the core makeup tank shell side 64 of the heat exchanger 42 to repeat the process. Both the ultimate heat sink loop and the core makeup tank primary loop are driven by natural circulation flow. The core makeup tank primary loop flow continues to remove heat from the reactor even after steam enters the core makeup tank inlet piping 84.

During an accident in which coolant is lost from the reactor pressure vessel 10, the water level in the reactor vessel drops as the passive residual heat removal heat exchanger 42 removes decay heat from the reactor 10. When the water level drops below the core makeup tank inlet piping entrance in the core exit region 82, steam enters the inlet piping and breaks the natural circulation cycle. At this point, the water inventory of the core makeup tank (excluding the secondary shell side 64 of the passive residual heat removal heat exchanger) flows downward through the outlet piping 88 under the steam pressure and into the reactor pressure vessel downcomer 78, effectively serving as a high head injection. This combined high head injection from the core makeup tank and residual heat removal heat exchanger combination is more fully described in application Ser. No. 13/495,069, filed Jun. 13, 2012.

The embodiment illustrated in FIG. 4 combines the features of the combined core makeup tank high head injection and residual heat removal system, automatic depressurization system, and low head injection with an in-containment reactor recirculation system that provides core cooling, without outside power, over an extended period, to which this invention can be applied to reduce the adverse affects of an inadvertent actuation of the depressurization system.

In one embodiment of the small modular reactor system, illustrated in FIG. 4, the integral reactor vessel 10 is inside a small high pressure containment vessel 34 as previously mentioned. The containment vessel 34 is substantially submerged in a pool of water 90 to provide external cooling to the vessel. Inside the vessel is an in-containment pool system 92 that comprises in-containment pool reservoirs 94 connected to in-containment pool tanks 96 located at an elevation above the reactor core 14. The in-containment pool reservoir 94 is split into two halves, each connected to one in-containment pool tank 96. A first set of automatic depressurization system valves 102 are connected to the top of each core makeup tank. A second set of automatic depressurization system valves 103 (figuratively shown by the vertical arrow) are connected by independent conduits to the core exit region 82 of the reactor vessel 10. The purpose of these valves is to depressurize the reactor and equalize the pressure between the containment volume and the reactor vessel volume. This is necessary to initialize the low pressure water injection system (in-containment pool) and recirculate water into the reactor from the containment pressure vessel under gravity.

The in-containment pool system 92 is connected through the in-containment pool reservoirs 94 to sump injection nozzles through check valves 104. The check valves allow flow from the in-containment pool system through the in-containment pool reservoirs 94 to the reactor coolant system. The in-containment pool system 92 is also connected to a lower portion of the containment interior volume or containment sump 98 through check valves 101. The check valves allow flow from the containment sump 98 to the in-containment pool system 92. The in vessel retention valves 106 allow the water in the in-containment pool system 92 to flow into the reactor vessel cavity and cool the interior of the reactor vessel preventing the core from melting through the reactor vessel wall.

The steam generator secondary side 108 is connected to an external steam drum 32 that separates the wet steam coming from the steam generator heat exchanger into dry steam and water. The heat removal capability of the water in the steam drum may also be used after an accident. The operation of the steam generator is more fully described in application Ser. No. 13/495,069, filed Jun. 13, 2012. The steam drum 32 can be isolated by closing off the isolation valves 110 and 112.

The operation of the safety system can be demonstrated through a review of the sequence of events that will occur following a postulated loss of coolant accident. A loss of coolant accident occurs when a primary pipe breaks inside the containment. As there are no large primary pipes in an integral reactor, the primary pipe break will be on auxiliary connections to the reactor like the pressurizer spray line on the pressurizer 22 or the connections to the core makeup tanks 40, such as the sump injection line. These lines will be limited in diameter to under six inches.

The first step in a loss of coolant accident sequence is the diagnosis by the protection and safety monitoring system 114 that an event is in progress. The protection and safety monitoring system then generates a protection system signal which results in the insertion of the control rods into the core 14 and a trip of the reactor coolant pumps 28. The steam drum 32 will be isolated from the steam generator by closing off the wet steam line 110 and the feed water recirculation line 112 from the steam drum to the steam generator.

The second step is opening the valves 80 below the core makeup tanks 40 which results in the cold, borated water in the core makeup tanks being forced into the core, cooling it and keeping the core covered. The residual heat removal heat exchangers are also activated, and this initiates the natural circulation cooling flow from the hot leg, through the heat exchanger and into the downcomer. The secondary side cooling loop of the residual heat removal heat exchangers will transfer the heat to the ultimate heat sink pools 70. This cooling will continue until the water level in the reactor has dropped below the hot leg residual heat removal inlet connections in the reactor vessel 10. At this point, the water in the core makeup tanks start to drain into the downcomer.

A low water level in the core makeup tanks or another actuation signal will actuate the automatic depressurization system valves 102 and 103, equalizing the pressure between the reactor volume and the containment volume. As soon as the pressure in the reactor is low enough, the in-containment pool tanks 96 (only one of which is shown) will drain into the reactor under gravity through the in-containment pool reservoirs 94 and the check valves 104. The vent valves 120 on the in-containment pool tanks 96 will open with the automatic depressurization system valves 102 and 103 permitting the tanks to drain. The water in the in-containment pool tanks 96 will replenish the water in the core keeping the core covered as the water in the reactor boils off, releasing steam into the containment 34 through the automatic depressurization system valves 102 and 103.

The steam inside the containment 34 then condenses on the cold containment vessel which is submerged in the water pool 90 which is covered by a vented removable radiation shield 124. The condensed steam will be collected in the bottom of the containment in the sump 98, with the water level rising as more steam is condensed on the cold containment vessel wall. When the water level in the in-containment pool tanks 96 reaches a sufficient level, check valves will open allowing the water inside the containment to flow from the sump 98 into the in-containment pool reservoir 94 and back into the reactor through sump injection nozzles 100. This creates a continuous cooling loop with water in the reactor boiling off and the steam released into the containment through the automatic depressurization system valves 103. The steam condensate then flows back into the reactor through the in-containment pool system 92 under natural circulation. Through this process, the decay heat is transferred from the core to the water outside the containment 34. The water pool 90 outside the containment may boil off but can be replenished from the ultimate heat sink pool 70 through flow valves 122. The combined water in the ultimate heat sink pools 70 and outside containment pool 90 is sufficient to cool the reactor for at least seven days. After that either the ultimate heat sink water should be replenished via connections in the ultimate heat sink pools that allow for the addition of inventory to extend the cooling operation, or AC power should be restored to cool the ultimate heat sink pools. The protection and safety monitoring system 114, the in vessel retention valves 106, the steam drum isolation valves 110, 112, the in-containment pool tank vent valves 120, the automatic depressurization valves 102, and the core makeup tank isolation valve 80 do not rely on the availability of AC power. A more thorough understanding of the small modular reactor safety systems can be had by reference to co-pending U.S. patent application Ser. No. 13/495,083, filed Jun. 13, 2012.

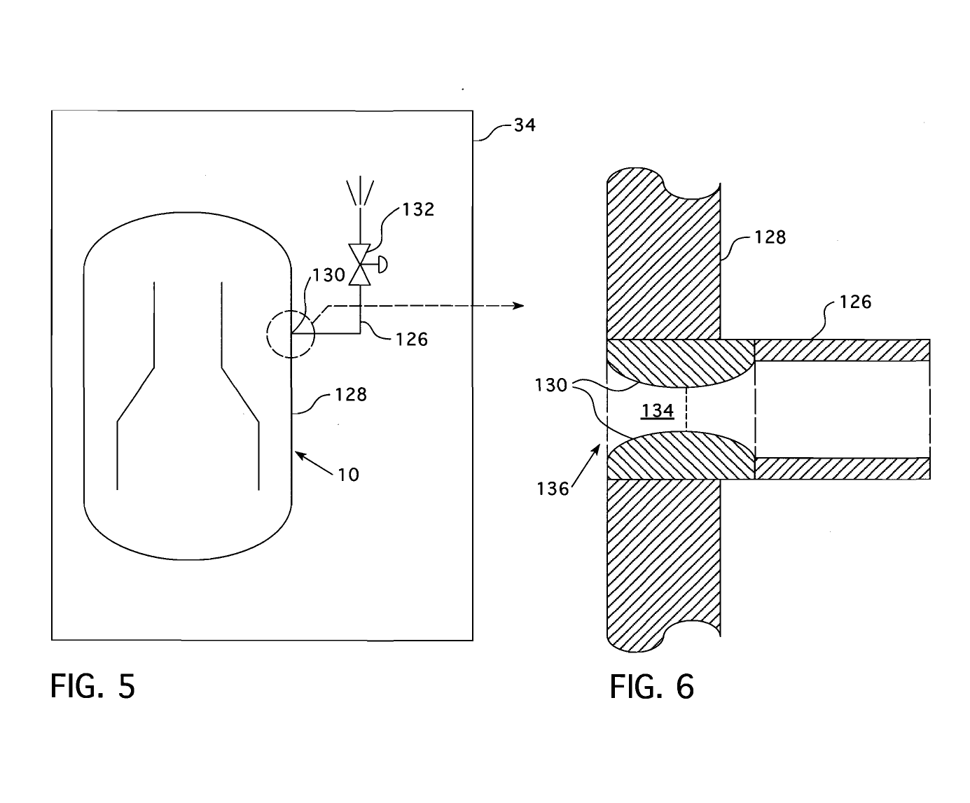

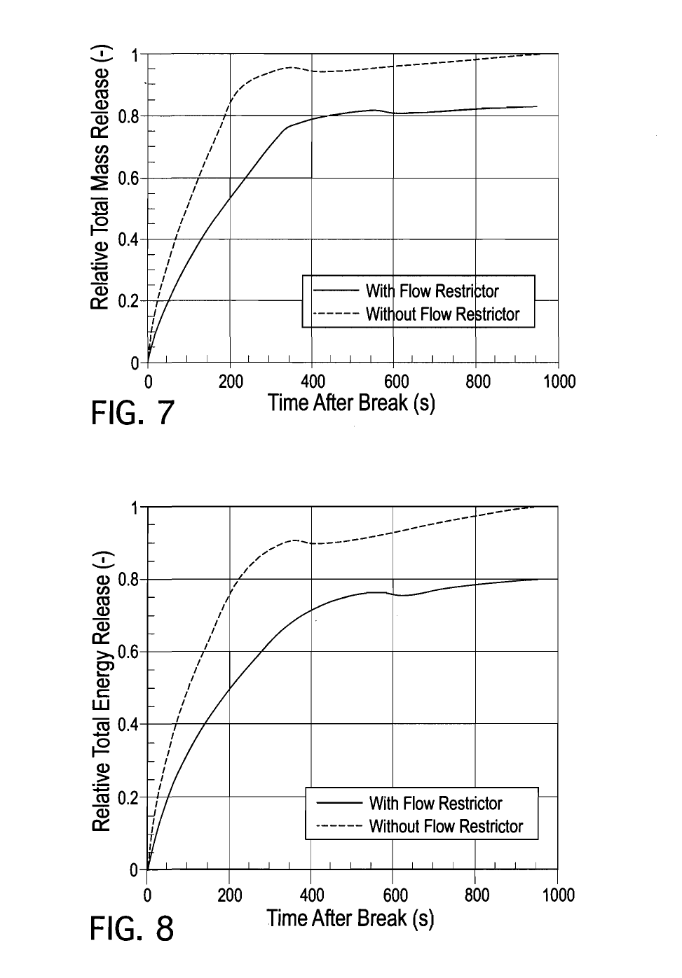

From the foregoing it can be appreciated that the low pressure water injection driven by gravity requires a sufficiently low pressure difference between the reactor vessel and the containment because of the limited driving water head. This invention provides a depressurization configuration to rapidly reduce the pressure in the reactor vessel and maintain a low pressure difference between the reactor vessel and the containment, while reducing the adverse effects caused by spurious opening or rupture of the depressurization system itself. One embodiment is illustrated in FIGS. 5 and 6 and connects a vent pipe 126 to an orifice 134 in and through the reactor vessel wall 128. Thus, in accordance with this embodiment, the depressurization system is comprised of a pipe 126 connecting the interior of the reactor vessel 10 and the interior of the containment with a flow restrictor 130 and a valve 132 on the vent pipe 126 as shown in FIGS. 5 and 6. As previously mentioned, the reactor vessel is maintained at a high pressure (greater than 2200 psi (15 MPa)) while the containment pressure is low in normal operation (less than 15 psi (0.1 MPa)). During normal operation the valve 132 in the depressurization system is closed to maintain the high pressure within the reactor vessel 10. In a loss of coolant accident, the valve in the depressurization system opens based on an electrical signal from the reactor protection system after a sequence of events indicative of a substantial loss of coolant, e.g., low pressurizer pressure or another signal, to release the high pressure fluid in the reactor vessel 10 into the containment 34, to further reduce the pressure in the reactor vessel. After depressurization, the valve opening is maintained to keep a low pressure difference between the reactor vessel and the containment.

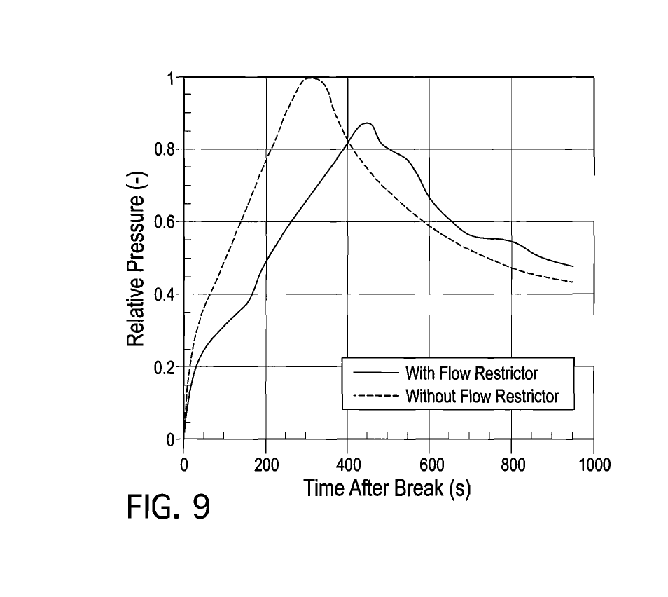

Thus, it should be appreciated that the failure of a depressurization system itself may create a safety challenge to the reactor core within the reactor vessel 10 and the containment 34. The failure considered herein is the inadvertent opening of the valve 132 or rupture of the connecting pipe 126 during normal reactor operation. In either case, the high pressure difference between the reactor vessel and the containment creates a critical flow from the reactor vessel to the containment. The critical flow rate depends on the minimum flow area pursuant to the fluid dynamics law. In accordance with this invention, a flow restrictor 130 installed at the inlet 136 of the depressurization system, as shown in FIG. 6, reduces the critical flow rate. The flow area of the restrictor 130 is less than the flow area of the connecting pipe 126 or the valves 132 in the depressurization system; therefore the critical flow is limited by the flow area of the flow restrictor 130. This is demonstrated in the total mass and energy release in the resulting containment pressure plots in FIGS. 7, 8 and 9 for the cases with and without a flow restrictor. Note that the values shown are normalized. The plots indicate a reduction with the flow restrictor 130 in the total mass and energy release into the containment 34 during an inadvertent valve actuation, leading to a reduction in the peak containment pressure.

To reduce the flow resistance of the flow restrictor 130 to assure that the depressurization system performs effectively in a non-critical flow mode, a venturi-type of flow restrictor with a gradual contraction and a gradual expansion of its central opening is employed as illustrated in the opening in the wall 128 at any location between the reactor vessel wall 128 and the valve 132. However, to be most effective, the venturi should be placed within the opening in the reactor vessel wall 128 to assure that it will function even if the break is at the pipe 126 connection to the reactor vessel wall 128. The flow area of the venturi preferably is the minimum flow area in the depressurization system.

Though the preferred embodiment described above is applied to a small modular pressurized water reactor, it should be appreciated that the invention claimed hereafter can serve a benefit to any reactor system, such as the AP1000®, that employs a fluid coolant within the reactor vessel that during operation is maintained at a higher pressure than the environment surrounding the exterior of the reactor vessel.

While specific embodiments of the invention have been described in detail, it will be appreciated by those skilled in the art that various modifications and alternatives to those details could be developed in light of the overall teachings of the disclosure. Accordingly, the particular embodiments disclosed are meant to be illustrative only and not limiting as to the scope of the invention which is to be given the full breadth of the appended claims and any and all equivalents thereof.

What is claimed is:

1. A nuclear power generation system comprising a reactor enclosed within a pressure vessel housed within a containment, the reactor operating at a higher pressure than an area surrounding the reactor in the containment, the reactor including a depressurization system for reducing the pressure within the reactor and venting the coolant within the reactor into the containment, the depressurization system comprising;
an orifice within the pressure vessel for venting the coolant within the pressure vessel into the containment; and
a flow restrictor in flow communication with the orifice for restricting a critical flow rate of a fluid within the pressure vessel out of the orifice while enabling sufficient flow of the fluid to substantially equalize the pressure within the pressure vessel with the pressure in the area surrounding the reactor.

2. The nuclear power generation system of claim 1 wherein the flow restrictor has a reduced opening compared to openings in other conduits in the depressurization system and the reduced opening is gauged to provide a minimum critical flow required by the depressurization system.

3. The nuclear power generation system of claim 1 wherein the flow restrictor is a venturi.

4. The nuclear power generation system of claim 3 wherein the venturi has a gradual transition between a maximum diameter and a minimum diameter of an opening through the venturi within which the depressurization is communicated.

5. The nuclear power generation system of claim 1 wherein the orifice extends through a wall of the pressure vessel and includes a conduit that extends from the pressure vessel to a valve for isolating the orifice until the depressurization system is actuated, wherein the flow restrictor is positioned through the orifice in the pressure vessel wall.

6. The nuclear power generation system of claim 5 wherein a flow area of the flow restrictor is less than a flow area of the conduit or the valve.

7. The nuclear power generation system of claim 5 wherein the flow restrictor is positioned within the pressure vessel wall.

8. The nuclear power generation system of claim 1 wherein the reactor is a pressurized water reactor.

9. The nuclear power generation system of claim 8 wherein the reactor is a small modular pressurized water reactor.
